(19) United States
(12) Patent Application Publication
(10) Pub. No.: US 2005/0264455 A1
(43) Pub. Date: Dec. 1, 2005

(54) Actively tunable planar antenna

(75) Inventors: Olli Talvitie, Tampere (FI); IIkka Pankinaho, Paimio (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/854,765

(22) Filed: May 26, 2004

(51) Int. Cl. H01Q 1/24

(52) U.S. Cl. 343/702; 343/700 MS

(57) ABSTRACT

This invention relates to an actively tunable patch antenna comprising a ground plane, a planar radiator, a feed point, a grounding line and first and second antenna branches separated from each other by a groove, the patch antenna further comprising one or more additional grounding points between the planar radiator and the ground plane. The invention further relates to a mobile terminal utilizing the tunable patch antenna of the invention.

### FIELD OF THE INVENTION

The present invention relates to actively tunable patch antennas. The invention relates more specifically to actively tunable patch antennas used internally in mobile terminals.

### BACKGROUND OF THE INVENTION

Demand for smaller mobile terminals is growing all the time. At the same time there is a need for the mobile terminal to be able to operate on several continents and on several frequency bands (for example GSM 900, GSM 1800 and GSM 1900). And in the future, when new mobile terminals with new technologies are implemented, the mobile terminal should be able to operate on the frequency bands of these technologies also (for example WCDMA 2000 or US GSM 850).

The diminishing size of the mobile terminal and the requirement to be able to operate on several frequency bands sets requirements for the design of the mobile terminal. Especially small antenna structures with a wide bandwidth on several frequency bands is difficult to implement.

One implementation of a small antenna structure used in mobile terminals is a planar inverted F antenna (PIFA). Bandwidth of this type of antennas as such is narrow, but with the modifications described in the publication EP 1 202 386 it is possible to construct an antenna with wide bandwidth. In the antenna of the aforesaid EP publication grooves are added to the antenna element in order to lower the Q-value of the antenna and increase the bandwidth.

However, this type of antenna described in the EP 1 202 386 can only operate properly on one or two frequency bands. Especially two lower frequency bands (for example GSM 850 and GSM 900) can not easily be implemented at the same time. This would require the antenna to be high enough to work properly on both bands and have sufficient bandwidth and radiation efficiency.

In the publication EP 0 993 070 is described one type of planar inverted F-antenna, comprising one antenna branch which has an electrical length of ¼ wavelength. The antenna described in the publication can be tuned via additional grounding points. Its operation is however limited to only one frequency band.

There have been some attempts to actively tune the antenna to different frequency bands, but these configurations have been difficult to implement, especially on the lower frequencies. Also the bandwidth at the actively tuned frequency has been narrow, and the radiation efficiency low.

### SUMMARY OF THE INVENTION

The object of this invention is to provide a small antenna structure to be used for example in mobile terminals. The antenna of the invention can be actively tuned to operate on different frequency bands. The antenna structure according the invention is low in height allowing the manufacture of lower and smaller antennas. At the same time the antenna is equally or even more efficient than the earlier antennas.

### BRIEF DESCRIPTION OF THE DRAWINGS

FIG. 1 presents a slot antenna element according to an embodiment of the invention.

FIG. 2 present a dual slot antenna element according to an embodiment of the invention.

FIG. 3 presents the S11 of the slot antenna according to an embodiment of the invention without and with extra grounding.

FIG. 4 presents the efficiency of the slot antenna according to an embodiment of the invention without extra grounding and with extra grounding.

FIG. 5 present the S11 of the dual slot antenna according to an embodiment of the invention without extra grounding and with extra grounding in the lower band branch.

FIG. 6 presents the efficiency of the dual slot antenna according to an embodiment of the invention without extra grounding and with extra grounding in the lower band branch.

FIG. 7 presents the S11 of the dual slot antenna according to an embodiment of the invention without extra grounding and with extra grounding in the upper band branch.

FIG. 8 presents the efficiency of the dual slot antenna according to an embodiment of the invention without extra grounding and with extra grounding in the upper band branch.

FIG. 9 presents a block diagram of a part of a mobile terminal according to an embodiment of the invention.

### DETAILED DESCRIPTION OF THE PREFERRED EMBODIMENT

The radiating part of the antenna element according to an embodiment of the invention consists of one or two branches of a planar radiator starting at a feed point and ending to a grounding point forming a loop similarly as in the prior art antenna elements. The electrical length of the branches of the radiator is half wavelength. If the planar radiator consist of two branches, both branches can have their own grounding points, or they can have common grounding point if the ends of the branches are located close each other. There are also extra grounding points which are added to antenna element, these extra grounding points being located at a location between the feed point and the normal grounding point.

Normally the planar radiator consist of only one branch if the antenna element is to be used on only one frequency band, for example on the frequencies near 900 MHz or on the frequencies near 1800 MHz. If the antenna element is to be used on both lower and higher frequency bands the planar radiator usually consist of two branches. It is not necessary for both branches to have extra grounding points if there is no need to tune the antenna element on one both bands.

The characteristics of the antenna element can be altered by changing the places of the feed point, grounding points and the extra grounding points. Two examples of the antenna element according to an embodiment of the invention are described hereinafter.

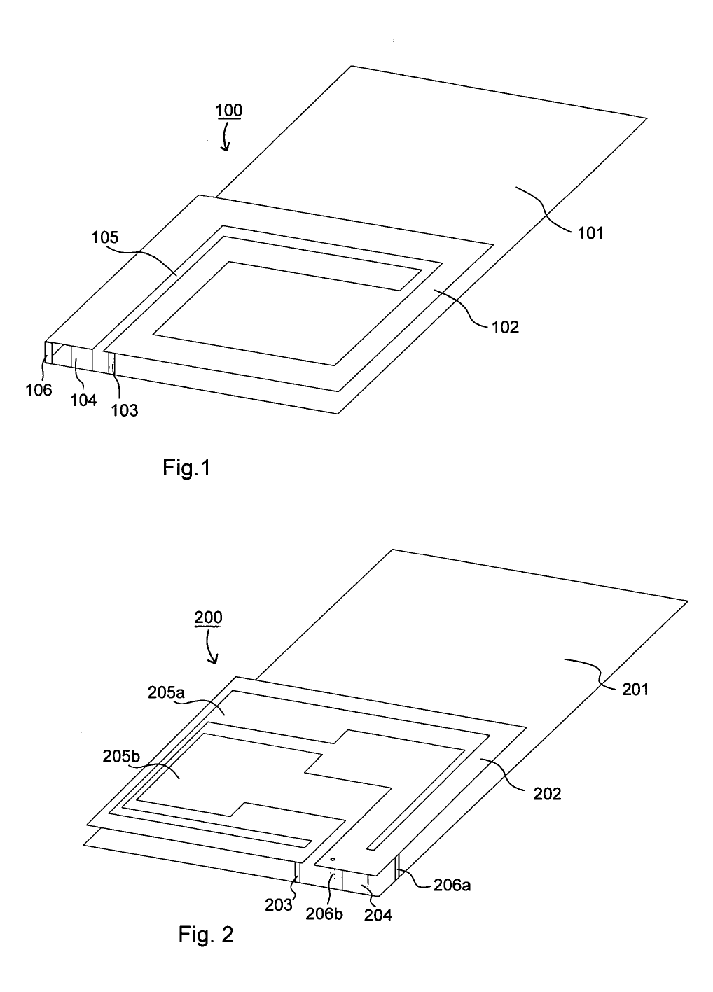

FIG. 1 presents the structure of the slot antenna element according to an embodiment of the invention. The slot antenna element 100 comprises a ground plane 101 and a planar radiator 102. The material between the ground plane 101 and the radiator 102 is electrically non conductive. The antenna 100 also comprises a feed point 103, a grounding line 104 for a ground point and a groove 105. Said groove is a portion that is not electrically conducting and can be implemented as described in the European patent publication EP 1 202 386 which is incorporated herein by reference. The principles of dimensioning of the groove and the antenna structure is also described in said publication.

The slot antenna element of the FIG. 1 also comprises an extra grounding line 106 at the edge of the radiator. This extra grounding line 106 provides an extra grounding point which increases the resonance frequency of the antenna. This extra grounding point may also be implemented as a point formed via (i.e., a point formed lead-through between different layers of the circuit board) in the area of the radiator. This extra grounding 106 can be implemented as a switch, which is open when no extra grounding is in use, and connected when it is desired for the antenna to operate on higher frequencies.

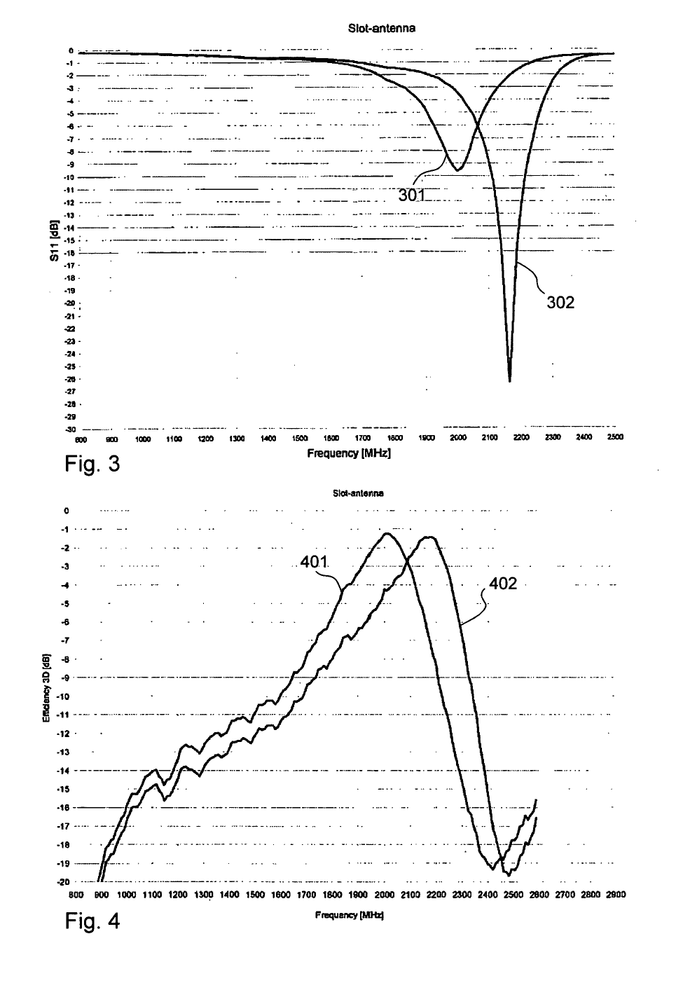

The effect of the extra grounding can be seen in the FIGS. 3 and 4. In the FIG. 3 is presented the S11 (input reflection coefficient) of the antenna with and without the extra grounding (302 and 301 respectively). As can be seen from the figure, with the extra grounding the resonance frequency of the antenna increases about 160 MHz. The amount of resonance frequency increase is dependent on how near the feed point 103 the extra grounding 106 is located.

In the FIG. 4 is presented the radiation efficiency of the antenna with and without the extra grounding (402 and 401 respectively). As can be seen from the figure, the resonance frequency of the antenna has increased about 160 MHz, but the radiation efficiency is approximately the same on the two frequencies in use.

FIG. 2 presents the structure of a dual slot antenna element according to the another embodiment of the invention. The dual slot antenna element 200 comprises a ground plane 201, a planar radiator 202, a feed point 203, a grounding line 204 for a ground point and a grooves 205a and 205b. Said grooves are portions that are not electrically conducting and can be implemented similarly as the groove of the previous example. One end of the branches of the planar radiator 202 defined by the grooves 205a and 205b is located at the feed point 203 and the other end at the grounding line 204.

The dual slot antenna element of the FIG. 2 also comprises an extra grounding line 206a at the edge of the radiator and extra grounding via 206b. The extra grounding line 206a is located at the lower frequency branch of the antenna and it provides an extra grounding point which increases the resonance frequency of the lower frequency band of the antenna. This extra grounding point may also be implemented as a point formed via in the area of the radiator.

The extra grounding via 206b is located at the higher frequency branch of the antenna and it provides an extra grounding point which increases the resonance frequency of the upper frequency band of the antenna. This extra grounding point may also be implemented as an extra grounding line in the area of the radiator. Both extra groundings 206a, 206b can be implemented as switches, which are open when no extra grounding is in use, and connected when the antenna is wanted to operate on higher frequencies.

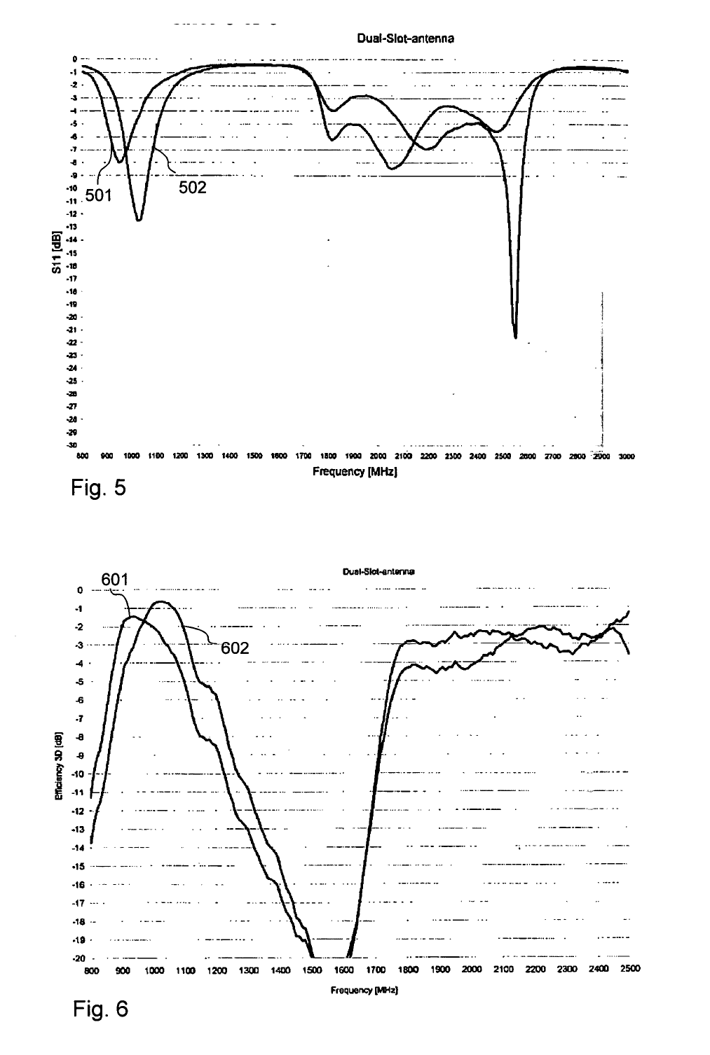

The effect of the extra grounding can be seen in the FIGS. 5, 6, 7 and 8. In the FIG. 5 is presented the S11 of the antenna with and without the extra grounding (502 and 501 respectively) on the lower frequency band. As can be seen from the figure, with the extra grounding the resonance frequency of the antenna increases also about 160 MHz at the lower frequencies, while the resonance frequency of the higher frequencies is unaltered.

In the FIG. 6 is presented the radiation efficiency of the antenna with and without the extra grounding (602 and 601 respectively) on the lower frequency band. As can be seen from the figure, the resonance frequency of the antenna has increased about 160 MHz, and the radiation efficiency is about 1 dB higher.

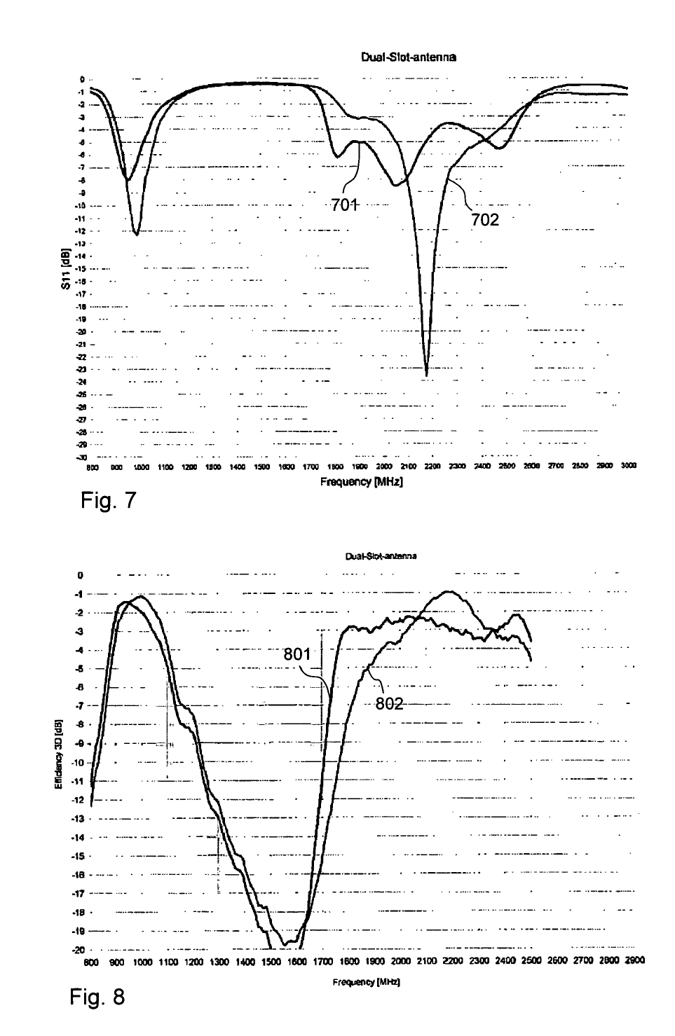

In the FIG. 7 is presented S11 and in FIG. 8 the radiation efficiency of the antenna with and without the extra grounding (702, 802 and 701, 801 respectively) on the higher frequency band. As can be seen, the resonance frequency of the antenna only changes a small amount on the lower frequencies when extra grounding is added to the higher frequency band. At the same time the resonance frequency on the higher frequencies changes the same 160 MHz as on the other examples. The radiation efficiency presented in FIG. 8 is about the same with or without the grounding.

As can be seen from the examples above, the adding of extra grounding does not affect the efficiency of the antenna. However the antenna can be operated on two or more frequency bands depending on the antenna structure. Tuning of the antenna can also be altered by varying the dimensioning of the antenna, for example by adding more capacitances or widening the antenna element.

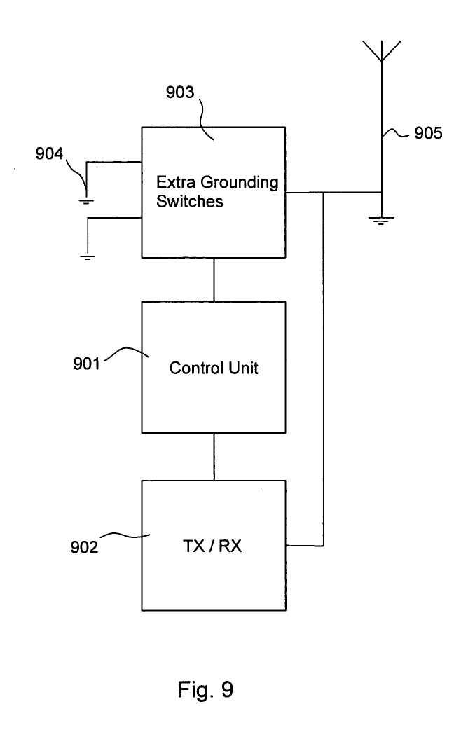

In FIG. 9 is presented a block diagram of a part of a mobile terminal utilizing the planar antenna element according to an embodiment of the invention. The mobile terminal comprises a control unit 901 for controlling a transceiver unit 902 and the extra grounding switches 903. There might be some other functions for the control unit 901 which are not shown or described herein. Extra grounding switches 903 connect the extra grounding points 904 to the antenna element 905 if it is desired to change the operating frequency of the antenna element 905.

For example the mobile terminal might be operating on an area where there are both GSM 1800 and WCDA 2000 networks, and the terminal is currently using the WCDM 2000 network. There might come a situation when the signal power received at the base station is inadequate, and the base station orders the mobile terminal to switch to another network in order to maintain the connection. The control unit 901 orders the transceiver unit 902 to change to the new frequency band, in this case the GSM 1800 band, and at the same time it connects or disconnects extra grounding points 904 required for the antenna element 905 to operate properly on this new frequency band.

For the one skilled in art it is obvious that the description above does not limit the scope of the invention, and that the different alternatives of the invention are defined by the claims. For example there can be more than two additional extra grounding points if the antenna is wanted to operate on more than two additional frequency bands.

1. An actively tunable patch antenna comprising a ground plane, a planar radiator, a feed point, a grounding line and first and second antenna branches forming a loop separated from each other by a groove, the patch antenna further comprising one or more additional grounding points between the planar radiator and the ground plane.

2. An actively tunable patch antenna according to claim 1, wherein the additional grounding point is a grounding line.

3. An actively tunable patch antenna according to claim 1, wherein the additional grounding point is a point formed via.

4. An actively tunable patch antenna according to claim 3, wherein the extra grounding point is added to the lower frequency branch of the antenna.

5. An actively tunable patch antenna according to claim 3, wherein the extra grounding point is added to the higher frequency branch of the antenna.

6. An actively tunable patch antenna according to claim 1, wherein the extra grounding point is implemented as a switch.

7. A mobile terminal using the actively tunable patch antenna according to claim 1 and further comprising a control unit and a transceiver unit.

8. An actively tunable patch antenna according to claim 1, wherein the extra grounding point is added to the lower frequency branch of the antenna.

9. An actively tunable patch antenna according to claim 2, wherein the extra grounding point is added to the lower frequency branch of the antenna.

10. An actively tunable patch antenna according to claim 1, wherein the extra grounding point is added to the higher frequency branch of the antenna.

11. An actively tunable patch antenna according to claim 2, wherein the extra grounding point is added to the higher frequency branch of the antenna.
